(19) United States
(12) Patent Application Publication
(10) Pub. No.: US 2002/0032735 A1
(43) Pub. Date: Mar. 14, 2002

(54) Apparatus, means and methods for automatic community formation for phones and computer networks

(76) Inventors: Daniel Burnstein, Brookline, MA (US); Carl Crawford, Brookline, MA (US); James M. Karet, Worcester, MA (US); Jay Lebed, Brookline, MA (US); Jeffrey Starfield, Watertown, AZ (US); George Wood, Scottsdale, AZ (US)

Correspondence Address: Daniel Burnstein, 35 Garden Road, Brookline, MA, 02445, US

(21) Appl. No.: 09/934,093

(22) Filed: Aug. 21, 2001

Related U.S. Application Data
(60) Provisional application No. 60/228,203, filed on Aug. 25, 2000.

(51) Int. Cl. G06F 15/16

(52) U.S. Cl. 709/204; 707/6

(57) ABSTRACT

An automatic telephone, Internet or intranet community formation system that utilizes spoken words or matching search terms. The invention utilizes wireless and wired voice communications, database and list serve technology to archive and match users based upon their search terms entered into a telephone system or a search engine, Internet, intranet, extranet, local area network, wide area networked, wired, wireless or standalone computer. A community formation system refers to a means of inviting one or more persons to communicate via voice, email or other method and join in a discussion. Invitations to join would be sent via an email, SMS, instant messaging, phone, web browser, email or fax communication. The user would have control over whether s/he wanted to be invited into a community, the age of desired matches, the closeness or breadth of the matches, the duration of the community, and the type of community—voice or text. Also, users have the ability to a.) conduct joint searches and b.) jointly and severally rate the content information, websites, or other subjects, and c.) to pick settings to establish his or her actual identity or to adopt an anonymous identity.

### FIELD OF THE INVENTION

The present invention relates generally to Internet search systems and a permission-based system to automatically match people using a computer or a phone based on their use of same or similar search terms.

### BACKGROUND OF THE INVENTION

One of the most important uses of the World Wide Web (Web) is to search out information contained in one or more servers on the Web. The problem is that the information contained on those servers, while currently totaling over one billion pages is often not the information a searcher might desire nor is it in a format that the searcher can utilize. Hence, people still need to “call up” other people to figure out how to do something, find something, some person or some information. Person to person communication has not been outmoded and will continue to be important in the coming years. This is especially true in large organizations of 30,000 employees and larger where the proverbial left hand and right hand do not know what each is doing. As a result there can be costly duplication of effort. With their permission, this invention automatically matches of two or more persons on the Internet or an intranet in a large organization for the purpose of the creation a community of interest about a specific topic, product, process, place, person, team, organization, news item, job, project, technology and so forth.

This invention has benefit to the human resources of an organization in that these matches help build connections amongst people and teams within the larger organization—promoting a generous and lively atmosphere in which the whole is greater than the sum of its parts.

This invention also relates generally to computerized searching of large electronic databases or telephonic systems, wired or wireless, for an automatic electronic community formation system that creates new communities with chat and other community functions. The invention finds matching search terms and invites the searchers to join. The present invention applies to telecommunication networks, the Internet, local area networks, wide area networks, intranets, extranets, and standalone computers.

The Internet presents the dual problems of information overload and a dearth of human contact and wisdom. This lack of human contact has helped to foster the popularity of online chat, bulletin boards and online communities such as Motley Fool, the Yahoo Clubs, The Well, Nyx, Metropolis, MUDs, PPP/SLIP, Usenet Newsgroups, IRC, Pics OnLine, PcBoard, GeoCities.com, and Tripod.com.

The lack of wisdom comes from the lack of quiet contemplation and discussion before large-scale action is undertaken. Before decisions are made, the wisdom of experience and analysis can be tapped with the aid of this invention. Which road to travel is often more important than the speed one drives—especially if a wrong turn is thus avoided.

Large corporations, non-profits and governmental organizations have grown to value the enhanced efficiencies that arise from collaboration and knowledge sharing. Hence the growth of networked computers and applications such as IBM's Lotus Notes. For instance, a multi-national manufacturing and service company with branches in a multitude of countries may find it has a failure of communication. Its corporate leaders and teams might lose touch with what other teams and individuals are working on. They would appreciate a permission-based system that allows employees to find others who have similar interests.

Likewise, government, quasi-governmental agencies like NIST, CDC, FDA, NAS, NRC, the Executive Branch in general, a large non-profits can grow to be so large that people engaged in similar work can remain unknown to each other, resulting in costly duplication of effort, time and resources.

There is to the inventor's knowledge currently no tool that allows people to be matched based on their search strings. This will help identify growing areas of organizational interest. To serve this need there are at least two companies who have products that search all the email and create a knowledge map of who is working on what topic with their permission. This present invention is helps individuals connect earlier in their thinking and is less intrusive than a search of everyone's email.

Electronic networks (e.g., the Internet) provide a number of services for its users. The primary services relevant to this patent application are communities or stand alone chat rooms, bulletin boards, list serves, electronic mail (email) and databases.

One of the major driving forces in the growth of networks in general and the Internet in particular has been the way it facilitates people's ability to find others of similar interests. Chat, bulletin boards, date matching services and list services are among the most popular activities on the net. People have a need to meet people and overcome the limitations of their physical separation.

However, the two main weaknesses of these existing systems is that they (1) require users to answer a number of questions and (2) these questions are limited to what is known about the present or past but not easily adaptable to new developments in the future. Such systems would by their nature are basically fixed and limit the matches to the predetermined records and fields of the profile. If the participants or designers of the existing matching systems fail to anticipate a new topic, issue, fact or future then a matching cannot occur.

### SUMMARY OF THE INVENTION

The invention covers the apparatus, means and methods for automatically matching based upon the search terms entered into a telecommunications system, the Internet (World Wide Web), standalone computer, intranet or extranet. Further, it provides a means and method of comparing that search with prior search terms entered by others to make a match between similar searches—without needing to pre-determine a need to track this term a priori. After making a match the invention automatically invites the matched parties to join a frictionless and immediate electronic community if they so desire. These communities may be as small as just two and as large as tens, hundreds or thousands of participants.

Who will benefit from this invention? People who are having trouble utilizing their new product purchase, such as a computer or telescope and would like to talk, chat, or email with someone who has bought the same or similar product earlier and figured out how to use it. Also, someone researching a rare disease and seeking a medical expert might use this invention with life saving results. Or for emotional reasons a user might want to communicate with someone who has had the same experience of relative dying or going through a divorce or layoff.

What else exists today that provides a portion of the functionality of the intention? Currently such Internet destinations as ICQ, AOL and other chat rooms, list serves, and Usenet groups are set up around a particular topic. These are collected and administered or archived by Yahoo, ICQ, AOL, Topica and Google to name a few.

The problem is that there typically needs to be a critical mass of 5-500 users to provide enough people to cover a wide range of questions that might be asked on any given topic. This invention only requires that there be as little as two people who have a similar interest. Even if the earlier searcher is not currently looking for information on this subject this invention “remembers” his or her interest and automatically asks permission to make a match with someone who is interested.

Who kind of searches work best with the invention? The more specific the search the more targeted is the results. For instance someone searching for “Jaguar” might get matched to people interested in cars, a cat, a Florida football team, a type of computer. So users who search for “Jaguar 120” will only get matched with others interested in that particular classic car model and not the jungle animal.

List serves are one of the components of this system. Email can be subdivided into one-to-one delivery and one-to-many. One-to-many is supported by a list serve that maintains a distribution list and postings from interested individuals. The distribution lists send email directly to the members of the list serve. An example of the one-to-many email services is Usenet. Herein, we define the “many” in one-to-many as a community. Questions on a topic of interest to a community can be posed to members so those users can solve problems. A key purpose of any community is to provide users a way to ask for or share information with other users. A problem with list serves is that there may not be any current users who care or know about a particular question or topic. Existing communities might be too broad or simply not exist for a particular topic.

The web is a database distributed across many computers. The various computers are connected electronically via hyperlinks in the data itself. A derivative service of the web is a means, described or referred to as “a search engine,” that enables users to locate information in the distributed database. An object of search engines is to help users find information on the Web. Users often times have difficulty obtaining information because the search engines find too much or too little relevant information. Users also have trouble finding other people of similar interests.

The object of this invention is for users to combine the services of search, email, phones, fax and the web to form communities. The present invention is designed to operate multiple modes: with a person using a standalone computer, with a computer that provides communication to users with an archival database, with a computer or phone handset on a data or telecommunications network, with a wireless phone, with automated agents.

Users can communicate with the computer via direct network connections, serial lines (e.g., a modem connection), or directly via a keyboard/monitor combination. Users may be identified using various means including their email address, their login name, or other unique identifier; denoted their ID, or some combination of these. Other means of identifying users are possible and the present invention is not limited to those listed here.

The initial interaction of the user with the computer or phone is to search for data. In the present embodiment of the invention, the data could be located on the computer itself, in distributed databases over a network connection, e.g., the Internet, intranet, extranet or over a telephone system. The user performs a search utilizing natural language consisting of a series of keywords, phrases, or sentences, called a “search string.” Other types of search strings or search input are possible. The computer has means to pass the search string or search input to a search engine, which could be located on the computer itself or remotely on the network.

The invention will take people matched by their search string or voice in/out and if it finds a match offer them the opportunity to enter an existing community or create a new community. This will be a text, avatar (graphical representation) or voice chat room for instant or real-time conversation via text or speech. There could be a “bulletin board” for posting asynchronous communication. The community might contain useful links to information, goods and services. The community will provide users with user preferences to control the look, feel and functionality of the community. For example users may not want a chat room and only want a bulletin board. Users may or may not want to shop from a community. Users may or may not want the community to suggest links to information, goods and services. The invention gives users control over these details.

The computer also contains a storage mechanism (e.g., a disk) on which a database is maintained. In the present embodiment of the invention, there is database. This database provides a method of keeping track of search entries and who made those searches. The database maintains a set of entries containing the user ID, an associated search string, and a name or names of a relevant community(s).

A community is a gathering of two or more people, virtual people or intelligent agents. A community contains a text or voice chat room and a bulletin board and useful links.

When the user uses this invention s/he enters a search string consisting of a word or a phrase and the search string is saved into the database, the community field is set to an empty string, denoted null. The invention then attempts to make match between a current search by one person and previous searches by one or more other person(s). The invention can also attempt to locate (match) a current search string with existing communities on the Internet, a telecommunications system or elsewhere. These existing communities might have been set up previously by the invention or exist elsewhere on a network. The invention stamps the time and date of the search. In a preferred embodiment of the invention, the database is routinely purged of entries older than a specified date.

Matching telephone or Internet users based on any search terms with anyone else in the world subscribing or otherwise able to access this invention creates frictionless worldwide voice- or data-based communities assembled in real-time with little overhead or bureaucracy.

Users are not required to enter ahead of time a profile or any information about themselves. It is possible but not required to gather contextual information from the larger universe of identifiers that indicate this person is a member of a consumer, chemical, electronics, scientific, engineering, arts, social services, other industry verticals, or indicators of other broad categories about the type or nature of the user. For example, this information can be derived from their passage through a hierarchical search, a password, name of their originating site or the domain of the user.

A preferred embodiment of the invention should give users the ability to simply turn off the matching feature from their computer, browser or telephone. Also the invention can provide for levels of permission and levels of security. Likewise, an embodiment of the invention allows the users to specify the age of search matches. For example, a user might ask that no search match older than 6 months occur and another user might insist that no match older than 3 weeks be made.

After the user has entered his/her search string, the computer checks all other entries in the stored database to see if the present search string matches a previous search string in the database. This database incorporates one or more of the following methods: words in a database (with triggers or without), a hash table (faster but more memory intensive), a flat text file, an associative array (built on top of a hash table), or rules in a forward-chaining production system (fast but memory intensive). This same invention can be used on a telephone via sounds with associated meaning stored by a voice to text software program to the invention, such as Naturally Speaking or Via Voice. This enables the present invention for use on a data network and, or, telephone system to facilitate making matches over analog, digital or mixed phone and computer systems.

The mechanisms for implementing matching for a search string include the following methods: simple string match—does a word or series of words in the query match an item in the stored database within the system; a weighted string match—for each word in the query assign points to items in the system based on an inverse overall frequency score so that ‘rare’ words get higher scores than common words and return the items with the highest overall scores.

On these match methods the invention incorporates a number of methods as follows: closeness, increase the score where words matching in the item are close to each other in the query and/or item; thesaurus expansion: expand search words by adding synonyms; thesaurus inclusion, add synonym cross-reference to indexing mechanism instead of adding them to the search string; sounds-like: base search on soundex or similar codes instead of words; soundex-enhanced thesaurus: add words or cross-references based on synonyms of soundex-expansions; syntactic connectedness: increase the score where the words fall on the same branch of a parse tree (using any of several parsing methods); semantic connectedness: replace the syntactic parse with semantic analysis, based, for instance, on CYC technology or simpler forms of transformational analysis.

If a match is made, then one of two actions are taken depending if the community field in the matched record is null.

The first action is to consider the case of a null community entry. The invention contacts the currently searching and the previously searching users and asks them if they want to join a new community on the topic of the search string in the following manner. Initially the current searching user is contacted by the invention automatically. If that person indicates their interest in joining a community then the second action of the invention is to locate non-searching user(s) in the matched field and contacted them and ask if they want to join this community. If each answers in the affirmative, the invention automatically asks permission to form a new community and if the permission is granted the users are entered as members of that community.

The invention picks a name for the community that the users can later change. The name of the community is inserted into the database in the records of the present user and the matched user(s). Both the currently searching and the formerly searching users must agree to be in the community and the nature of the community, e.g., whether the community will be open to others or a closed confidential community. Another embodiment of the invention matches a searching user with members of existing communities found outside the invention but existing on a telephone system, the Internet, an intranet, extranet or standalone computer.

A community for the invention is defined as a list of two or more users that wish to communicate with each other based upon matching words of a search string. The matched search string or variation identifies the list. The list contains the telephone number or email addresses of the users. Users can remain anonymous if they so desire.

In the case of a non-null community entry, after the match is made only the present user is invited to join the already existing community. If the user answers in the affirmative, then the present user is added by the invention to the list for that extant community. The name of the community is added to the database for the present user. While the above text describes the primary embodiment of the invention, additional variations are now described. When matches are attempted, the invention adds contextual information to the user's search string. Users have input and output via telephone, email, a person, fax, surface mail, or web-based email.

### BRIEF DESCRIPTION OF THE DRAWINGS

The present invention together with the above and other advantages may best be understood from the following detailed description of the embodiments of the invention illustrated in the drawings, wherein:

FIG. 1 is a block diagram of the invention and its relationship to the Internet or an intranet or a telephone system, the computer, the search engine, a listserve, a database server.

FIG. 2 is a block diagram of the E-COMMUNITY DATABASE showing various records, e.g., Record 1, Record 2, . . . , Record i.

FIG. 3 is a block diagram of Record i [Required information] and indicating the User ID, Search string, Community.

FIG. 4 is a block diagram of Record i [Optional information] with the date/time, context, scope measure, matching disable, anonymity, match age of request.

FIG. 5 is a block diagram of the record 1 after a sample search by dan@buzzit.com for “Boston Red Sox” User ID: dan@buzzit.com, Search string: “Boston Red Sox”, Community: Null.

FIG. 6 is a block diagram of the record 2 after search by carl@myisp.com for “Boston Red Sox” User ID: carl@myisp.com, Search string: “Boston Red Sox”, Community: Null.

FIG. 7 is a block diagram of the Records 1+2 after dan@buzzit.com and carl@myisp.com agree to form a community: “Boston Red Sox” with Records 1 and 2: Record 1, User ID: dan@buzzit.com, Search string: “Boston Red Sox”, Community: “Boston Red Sox” Record 2, User ID: carl@myisp.com, Search string: “Boston Red Sox”, Community: “Boston Red Sox”.

FIG. 8 is a block diagram of the Listserver after dan@buzzit.com and carl@myisp.com agree to form community “Boston Red Sox”, Community: “Boston Red Sox”, Members: User ID: dan@buzzit.com, User ID: carl@myisp.com.

### DETAILED DESCRIPTION OF THE INVENTION

Electronic networks (e.g., the Internet) provide a number of services for its users. The primary services relevant to this patent application are communities or stand alone chat rooms, bulletin boards, list serves, electronic mail (email) and databases. FIG. 1.

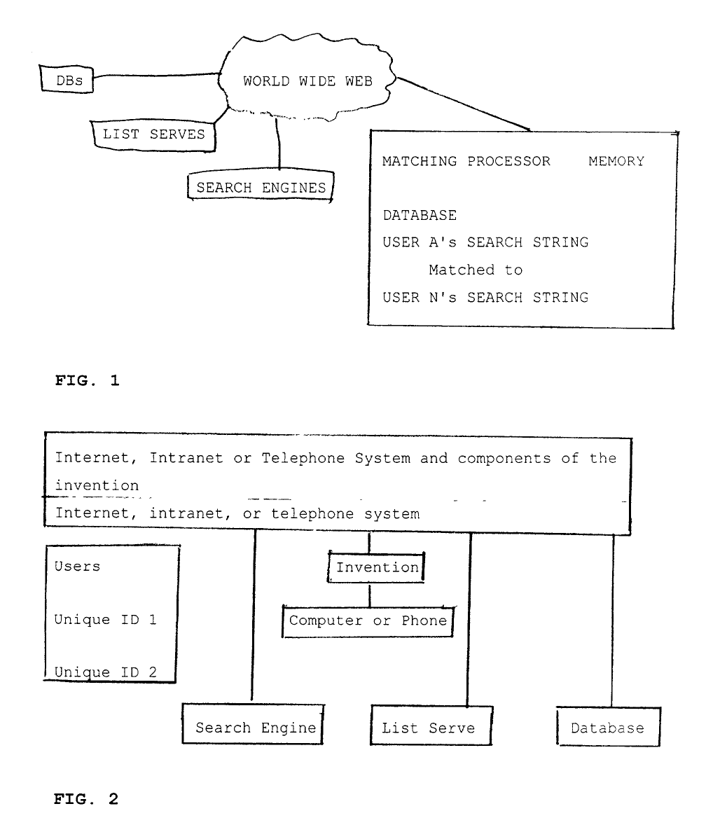

One of the major driving forces in the growth of networks in general and the Internet in particular has been the way it facilitates people's ability to find others of similar interests. Chat, bulletin boards, date matching services and list services are among the most popular activities on the net. People have a need to meet people and overcome the limitations of their physical separation. FIG. 2.

However, one of the weaknesses of these existing systems is that they require users to either (1) enter a pre-defined gathering space or answer questions or (2) create a pre-determined profile. Such previous systems would by their nature limit the matches to the predetermined records and fields or a profile. If the participants or designers of existing matching systems fail to anticipate a new topic, interest or future need matching cannot occur.

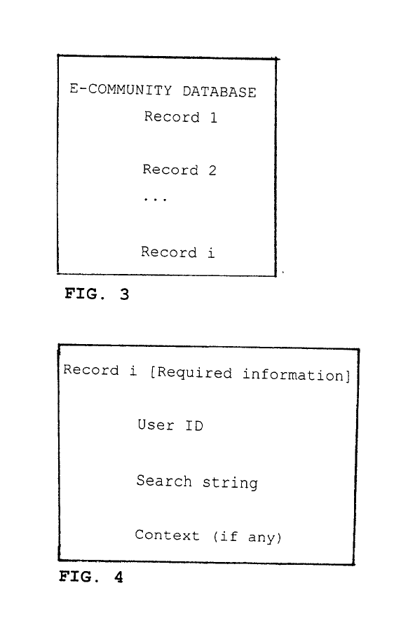

This patent covers the apparatus, means and methods for automatically matching based upon the search terms entered into a telecommunications system, the Internet (World Wide Web), standalone computer, intranet or extranet. Further, it provides a means and method of comparing that search with prior search terms entered by others to make a match between similar searches—without needing to predetermine the basis for the match. After making a match the invention will invite the matched parties to join a frictionless and immediate electronic community if they so desire. These communities may be as small as just two people and as large as tens or hundreds of thousands of participants. FIGS 3-4. Who is benefited from this invention? People who are having trouble utilizing their new product purchase and would like to talk, chat, or email with someone who has bought the product earlier and figured out how to use it. Someone researching a rare disease and seeking a medical expert might use this invention with life saving results.

What else exists today that provides a portion of the functionality of the intention? ICQ, AOL and other Chat rooms, List serves, and Usenet groups are set up around a particular topic and these list serves are collected and administered or archived by Yahoo, ICQ, AOL, Topica and Google to name a few. The problem is that there typically needs to be a critical mass of 5-500 users to provide enough people to cover the wide range of questions that might be ask on any given topic. This invention only requires that there be as little as two people who have a similar interest and even if the earlier searcher is not currently looking for information on this subject this invention “remembers” his or her interest and offers to make a match.

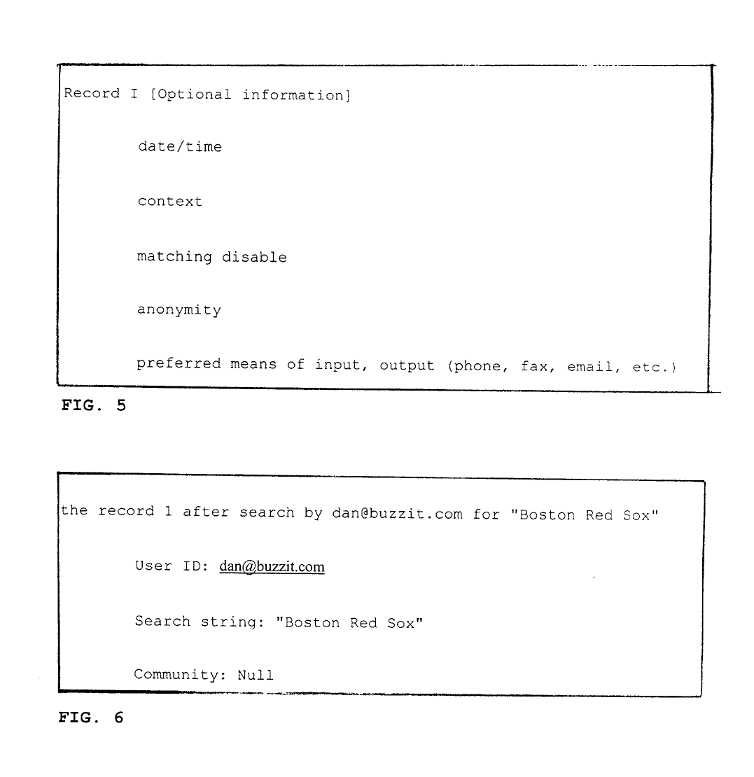

Who kind of searches work best with the invention? The more specific the search the more targeted is the results. For instance someone searching for “Jaguar” might get matched to people interested in cars, a cat, a Florida football team, a type of computer. So users who search for and XKE Jaguar acceleration will only get information about that car and not the jungle animal. In the preferred form of the invention a search is context sensitive and indicates the general area of desired information—the context of the search and the user can control the nature of the search. The user can look for prior searches based on time of search or number of similar searches. FIG. 5.

List servers are one of the components of this system. Email can be subdivided into one-to-one delivery and one-to-many. One-to-many is supported by list servers that maintain distribution lists. The distribution lists can be edited electronically by sending email directly to programs that maintain the lists. An example of the one-to-many email services is Usenet. Herein, we define the “many” in one-to-many as a community. Questions can be posed to community members so those users can solve problems. An object of a community is to provide users a way to ask for or share information with other users. Users who use a list serve or chat room often times cannot find communities to pose questions. Existing communities might be off-topic or too broad, or might not exist for a particular topic of interest.

The web is a database distributed across many computers. The various computers are connected electronically via hyperlinks in the data itself. A derivative service of the web is a means, described or referred to as “a search engine,” that enables users to locate information in the distributed database. An object of search engines is to help users find information on the Web. Users often times have difficulty obtaining information because the search engines find too much or too little information. Users also have trouble finding other people of similar interests.

The object of this invention is for users to combine the services of search, email, phones, fax and the web to form communities. The present invention is designed to operate in person using a standalone computer, or a computer that provides communication to users with an archival database, interface to a phone handset on a telecommunications or data network, a wireless phone, automated agents and an electronic list server.

Users can communicate with the computer via direct network connections, serial lines (e.g., a modem connection), or directly via a keyboard/monitor combination. Users may be identified using various means including their email address, their login name, or other unique identifier; denoted their ID, or some combination of these. Other means of identifying users are possible and the present invention is not limited to those listed here.

The initial interaction of the user with the computer is to search for data. In the present embodiment of the invention, the data could be located on the computer itself, in distributed databases over a network connection (e.g., the Internet, intranet or extranet) or over a telephone system. The user performs a search utilizing natural language consisting of a series of keywords, phrases, or sentences, called a “search string.” Other types of search strings or search input are possible. The computer has means to pass the search string or search input to a search engine, which could be located on the computer itself or remotely on the network. FIG. 6.

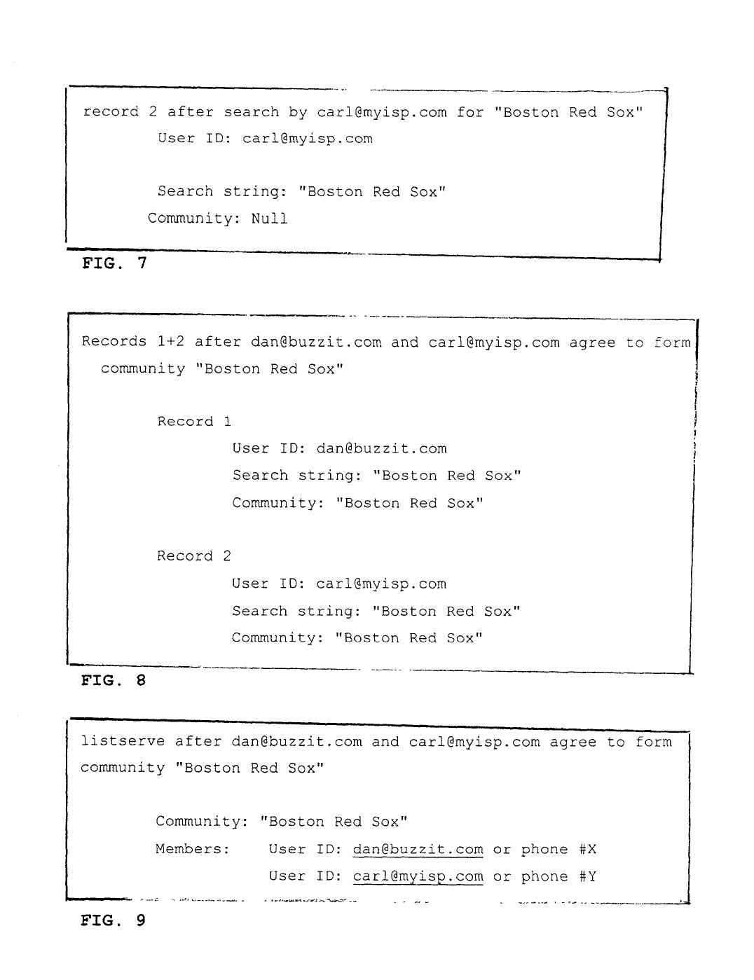

The invention will take people matched by their search string or search input and offer them the opportunity to enter an existing community or create a new community consisting of a text or voice chat room for real-time conversation via text or speech and a bulletin board. The community can also contain useful links to information, goods and services. Also the community will provide users with preferences to modify the look, feel and functionality of the community. For example users may not want a chat room and only want a bulletin board. Users may or may not want to shop from a community. Users may or may not want the community to suggest links to information, goods and services. FIG. 7.

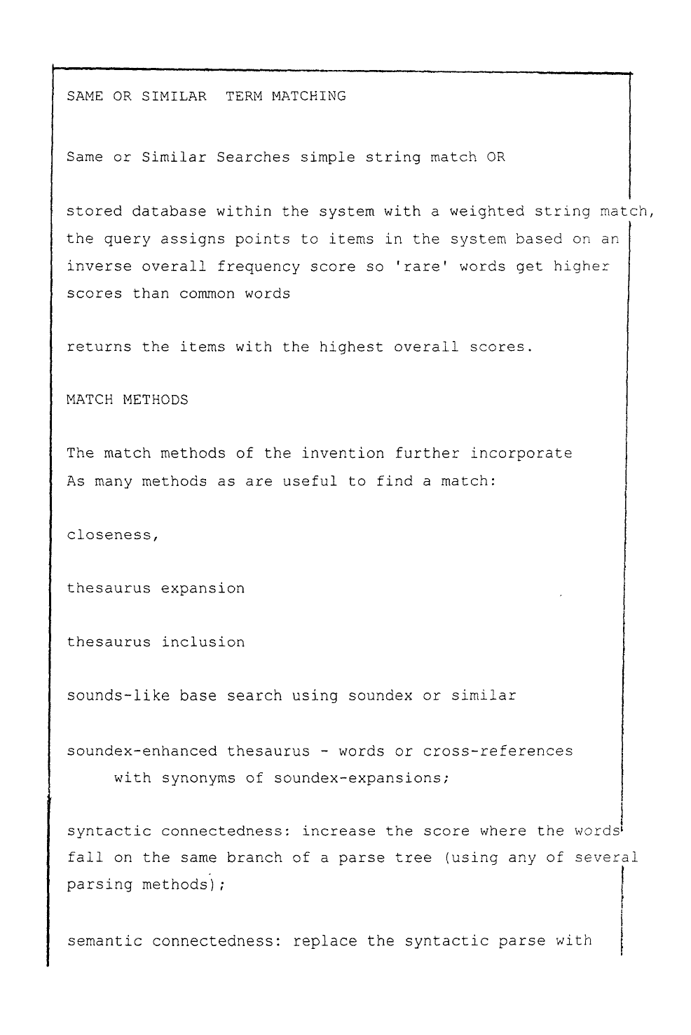

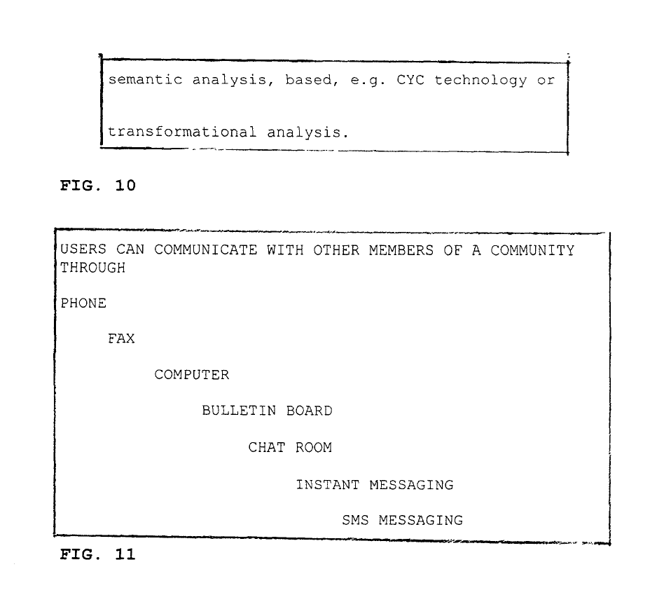

The computer also contains a storage mechanism (e.g., a disk) on which a database is maintained. In the present embodiment of the invention, there is database. This database provides a method of keeping track of search entries and who made those searches. The database maintains a set of entries containing a user ID, an associated search string, and a name or names of relevant community(s). And it will contain a record of those wishing to be matched on any given search. A community is a gathering of two or more people, virtual people or intelligent agents. A community contains a text or voice chat room and a bulletin board and useful links. FIG. 8.

When the user enters a new search string and the search string is entered into the database, the community field is set to an empty string, denoted null. The invention will attempt to make match between a current search by one person and previous searches by one or more other person(s). The invention will also attempt to locate (match) a current search string with existing communities on the Internet, a telecommunications system or elsewhere. These existing communities might have been set up previously by the invention or exist elsewhere on a network. The invention stamps the time and date of the search. In a preferred embodiment of the invention, the database is routinely purged of entries older than a specified duration. FIG. 9.

Matching telephone or Internet users based on any search terms with anyone else in the world subscribing or otherwise able to access this invention creates frictionless worldwide voice-based or data-based communities assembled in real-time with no bureaucracy.

Users are not required to enter profile information about them. With permission, contextual information can be gathered from a larger universe of identifiers such as industry verticals or other broad categories about the type or nature of the user. For example, this information can be derived from their passage through a hierarchical search, a password, name of their originating site or the domain of the user.

A preferred embodiment of the invention should give users the ability to easily turn off the matching feature from their computer, browser or telephone. Also the invention can provide for levels of permission and levels of security. Likewise, an embodiment of the invention allows the users to specify the age of search matches. For example, a user might ask that no search match older than 6 months occur and another user might insist that no match be older than 14 days.

After the user has entered his/her search string, the computer checks all other entries in the stored database to see if the present search string matches a previous search string in the database. This database incorporates one or more of the following methods: words in a database (with triggers or without), a hash table (faster but more memory intensive), a flat text file, an associative array (built on top of a hash table), or rules in a forward-chaining production system (fast but memory intensive). This same invention can be used on a telephone via sounds with associated meaning stored by a voice to text software program to the invention, such as Naturally Speaking or Via Voice. This enables the present invention for use on a data network and, or, telephone system to facilitate making matches over analog, digital or mixed phone and computer systems.

The mechanisms for implementing matching for a search string include the following methods: simple string match—does a word or series of words in the query match an item in the stored database within the system; a weighted string match—for each word in the query assign points to items in the system based on an inverse overall frequency score so that ‘rare’ words get higher scores than common words and return the items with the highest overall scores.

On these match methods the invention incorporates a number of methods as follows: closeness, increase the score where words matching in the item are close to each other in the query and/or item; thesaurus expansion: expand search words by adding synonyms; thesaurus inclusion, add synonym cross-reference to indexing mechanism instead of adding them to the search string; sounds-like: base search on soundex or similar codes instead of words; soundex-enhanced thesaurus: add words or cross-references based on synonyms of soundex-expansions; syntactic connectedness: increase the score where the words fall on the same branch of a parse tree (using any of several parsing methods); semantic connectedness: replace the syntactic parse with semantic analysis, based, for instance, on CYC technology or simpler forms of transformational analysis.

If a match is made, then one of two actions are taken depending if the community field in the matched record is null. The first action is to consider the case of a null community entry. The invention contacts the currently searching and the previously searching users and asks them if they want to join a new community on the topic of the search string in the following manner. Initially the current searching user is contacted by the invention automatically. If that person indicates their interest in joining a community then the second action of the invention is to locate non-searching user(s) in the matched field and contacted them and ask if they want to join this community. If each answers in the affirmative, the invention automatically forms a new community and the users are entered as members of that community.

The invention picks a name for the community that the users can later change. The name of the community is inserted into the database in the records of the present user and the matched user(s). Both the currently searching and the formerly searching users must agree to be in the community and the nature of the community, e.g., whether the community will be open to others or a closed confidential community. Another embodiment of the invention matches a searching user with members of existing communities found outside the invention but existing on a telephone system, the Internet, an intranet, extranet or standalone computer.

In the case of a non-null community entry, after the match is made only the present user is invited to join the already existing community. If the user answers in the affirmative, then the present user is added by the invention to the list for that extant community. The name of the community is added to the database for the present user. While the above text describes the primary embodiment of the invention, additional variations are now the most important uses of the World Wide Web (Web) is to search out information contained in one or more servers on the Web. The problem is that the information contained on those servers, while currently totaling over one billion pages is not necessarily the information a searcher might desire or it is not in a format that the searcher can utilize. Hence, person to person communication has not been outmoded and will continue to be important in the coming years. This is especially true in large organizations of 30,000 and up where the proverbial left hand and right hand do not know what each is doing and there are many costly examples of duplication of effort. This invention facilitates the matching of two or more persons in the public side of the Web and behind firewalls in large organizations for the purpose of the creation of two person and larger communities of interest about a specific topic, product, process, place, person, team, financial instrument, organization, news item, job, project, technology and so forth.

This invention relates generally to computerized searching of large electronic databases or telephonic systems, wired or wireless, for an automatic electronic community formation system that creates new communities with chat and other community functions. The invention finds matching search terms and invites the searchers to join. The present invention applies to telecommunication networks, the Internet, local area networks, wide area networks, intranets, extranets, and standalone computers.

### BACKGROUND OF THE INVENTION

The Internet presents the dual problems of an overabundance of data, sometimes called information overload, and a dearth of human contact, judgement or wisdom. This lack of human contact has fostered the popularity of online chat, bulletin boards and online communities such as Motley Fool, the Yahoo Clubs, The Well, Nyx, Metropolis, MUDs, PPP/SLIP, Usenet Newsgroups, IRC, Pics OnLine, PcBoard, GeoCities.com, and Tripod.com.

The lack of judgement or wisdom comes from the lack of time and attention given over to quiet contemplation and discussion before large-scale action is undertaken. Before decisions are made the wisdom of experience and analysis needs to be tapped. Which road to travel is often more important than the speed one attains—especially if the wrong turn is taken.

Large corporations, non-profits and governmental organizations value the enhanced efficiencies that arise from collaboration and knowledge sharing. For instance, a multi-national manufacturing and service companies with hundreds of branches in a multitude of countries often finds that they have a failure of communication and various corporate leaders and teams are unaware of what other teams and individuals are working on. They would like a permission-based system that allows employees to find others who have similar interests. Likewise, government and quasi-governmental agencies like NIST, CDC, FDA, NAS, NRC, the Executive Branch in general can be so large that people engaged in similar work can remain unknown to each other, resulting in costly duplication of effort, time and resources.

There is currently no tool that allows personnel to be matched based on their search strings. There are at least two companies who have products that search all the email and create a knowledge map of who is working on what topic with their permission. This invention is less intrusive.

### SUMMARY OF THE INVENTION

Electronic networks (e.g., the Internet) provide a number of services for its users. The primary services relevant to this patent application are communities or stand alone chat rooms, bulletin boards, list serves, electronic mail (email) and databases.

One of the major driving forces in the growth of networks in general and the Internet in particular has been the way it facilitates people's ability to find others of similar interests. Chat, bulletin boards, date matching services and list services are among the most popular activities on the net. People have a need to meet people and overcome the limitations of their physical separation.

However, one of the weaknesses of these existing systems is that they require users to either (1) enter a pre-defined gathering space or answer questions or (2) create a pre-determined profile. Such previous systems would by their nature limit the matches to the predetermined records and fields or a profile. If the participants or designers of existing matching systems fail to anticipate a new topic, interest or future need matching cannot occur.

This patent covers the apparatus, means and methods for automatically matching based upon the search terms entered into a telecommunications system, the Internet (World Wide Web), standalone computer, intranet or extranet. Further, it provides a means and method of comparing that search with prior search terms entered by others to make a match between similar searches—without needing to predetermine the basis for the match. After making a match the invention will invite the matched parties to join a frictionless and immediate electronic community if they so desire. These communities may be as small as just two people and as large as tens or hundreds of thousands of participants.

Who is benefited from this invention? People who are having trouble utilizing their new product purchase and would like to talk, chat, or email with someone who has bought the product earlier and figured out how to use it. Someone researching a rare disease and seeking a medical expert might use this invention with life saving results.

What else exists today that provides a portion of the functionality of the intention? ICQ, AOL and other Chat rooms, List serves, and UseNet groups are set up around a particular topic and these list serves are collected and administered or archived by Yahoo, ICQ, AOL, Topica and Google to name a few. The problem is that there typically needs to be a critical mass of 5-500 users to provide enough people to cover the wide range of questions that might be ask on any given topic. This invention only requires that there be as little as two people who have a similar interest and even if the earlier searcher is not currently looking for information on this subject this invention “remembers” his or her interest and offers to make a match.

Who kind of searches work best with the invention? The more specific the search the more targeted are the results. For instance someone searching for “jaguar” might get matched to people interested in cars, a cat, a Florida football team, a type of computer. So users who search for and XKE Jaguar acceleration will only get information about that car and not the jungle animal.

List servers are one of the components of this system. Email can be subdivided into one-to-one delivery and one-to-many. One-to-many is supported by list servers that maintain distribution lists. The distribution lists can be edited electronically by sending email directly to programs that maintain the lists. An example of the one-to-many email services is Usenet. Herein, we define the “many” in one-to-many as a community. Questions can be posed to community members so those users can solve problems. An object of a community is to provide users a way to ask for or share information with other users. Users who use a list serve or chat room often times cannot find communities to pose questions. Existing communities might be off-topic or too broad, or might not exist for a particular topic of interest.

The web is a database distributed across many computers. The various computers are connected electronically via hyperlinks in the data itself. A derivative service of the web is a means, described or referred to as “a search engine,” that enables users to locate information in the distributed database. An object of search engines is to help users find information on the Web. Users often times have difficulty obtaining information because the search engines find too much or too little information. Users also have trouble finding other people of similar interests.

The object of this invention is for users to combine the services of search, email, phones, fax, and the web to form communities. The present invention is designed to operate in person using a standalone computer, or a computer that provides communication to users with an archival database, interface to a phone handset on a telecommunications or data network, a wireless phone, automated agents and an electronic list server.

Users can communicate with the computer via direct network connections, serial lines (e.g., a modem connection), or directly via a keyboard/monitor combination. Users may be identified using various means including their email address, their login name, or other unique identifier; denoted their ID, or some combination of these. Other means of identifying users are possible and the present invention is not limited to those listed here

The initial interaction of the user with the computer is to search for data. In the present embodiment of the invention, the data could be located on the computer itself, in distributed databases over a network connection (e.g., the Internet, intranet or extranet) or over a telephone system. The user performs a search utilizing natural language consisting of a series of keywords, phrases, or sentences, called a “search string.” Other types of search strings or search input are possible. The computer has means to pass the search string or search input to a search engine, which could be located on the computer itself or remotely on the network.

The invention will take people matched by their search string or search input and offer them the opportunity to enter an existing community or create a new community consisting of a text or voice chat room for real-time conversation via text or speech and a bulletin board. The community can also contain useful links to information, goods and services. Also the community will provide users with preferences to modify the look, feel and functionality of the community. For example users may not want a chat room and only want a bulletin board. Users may or may not want to shop from a community. Users may or may not want the community to suggest links to information, goods and services.

The computer also contains a storage mechanism (e.g., a disk) on which a database is maintained. In the present embodiment of the invention, there is database. This database provides a method of keeping track of search entries and who made those searches. The database maintains a set of entries containing a user ID, an associated search string, and a name or names of relevant community(s).

A community is a gathering of two or more people, virtual people or intelligent agents. A community contains a text or voice chat room and a bulletin board and useful links.

When the user enters a new search string and the search string is entered into the database, the community field is set to an empty string, denoted null. The invention will attempt to make match between a current search by one person and previous searches by one or more other person(s). The invention will also attempt to locate (match) a current search string with existing communities on the Internet, a telecommunications system or elsewhere. These existing communities might have been set up previously by the invention or exist elsewhere on a network. The invention stamps the time and date of the search. In a preferred embodiment of the invention, the database is routinely purged of entries older than a specified duration.

Matching telephone or Internet users based on any search terms with anyone else in the world subscribing or otherwise able to access this invention creates frictionless worldwide voice-based or data-based communities assembled in real-time with no bureaucracy.

Users are not required to enter profile information about themselves. Contextual information can be gathered from a larger universe of identifiers that indicate this person is a member of a consumer, chemical, electronics, job search, transportation, scientific, engineering, arts, social services, other industry verticals, or indicators of other broad categories about the type or nature of the user. For example, this information can be derived from their passage through a hierarchical search, a password, name of their originating site or the domain of the user.

A preferred embodiment of the invention should give users the ability to simply turn off the matching feature from their computer, browser or telephone. Also the invention can provide for levels of permission and levels of security. Likewise, an embodiment of the invention allows the users to specify the age of search matches. For example, a user might ask that no search match older than 6 months occur and another user might insist that no match older than 3 weeks be made.

After the user has entered his/her search string, the computer checks all other entries in the stored database to see if the present search string matches a previous search string in the database. This database incorporates one or more of the following methods: words in a database (with triggers or without), a hash table (faster but more memory intensive), a flat text file, an associative array (built on top of a hash table), or rules in a forward-chaining production system (fast but memory intensive). This same invention can be used on a telephone via sounds with associated meaning stored by a voice to text software program to the invention, such as Naturally Speaking or Via Voice. This enables the present invention for use on a data network and, or, telephone system to facilitate making matches over analog, digital or mixed phone and computer systems.

The mechanisms for implementing matching for a search string include the following methods: simple string match—does a word or series of words in the query match an item in the stored database within the system; a weighted string match—for each word in the query assign points to items in the system based on an inverse overall frequency score so that ‘rare’ words get higher scores than common words and return the items with the highest overall scores.

On these match methods the invention incorporates a number of methods as follows: closeness, increase the score where words matching in the item are close to each other in the query and/or item; thesaurus expansion: expand search words by adding synonyms; thesaurus inclusion, add synonym cross-reference to indexing mechanism instead of adding them to the search string; sounds-like: base search on soundex or similar codes instead of words; soundex-enhanced thesaurus: add words or cross-references based on synonyms of soundex-expansions; syntactic connectedness: increase the score where the words fall on the same branch of a parse tree (using any of several parsing methods); semantic connectedness: replace the syntactic parse with semantic analysis, based, for instance, on CYC technology or simpler forms of transformational analysis.

If a match is made, then one of two actions are taken depending if the community field in the matched record is null.

The first action is to consider the case of a null community entry. The invention contacts the currently searching and the previously searching users and asks them if they want to join a new community on the topic of the search string in the following manner. Initially the current searching user is contacted by the invention automatically. If that person indicates their interest in joining a community then the second action of the invention is to locate non-searching user(s) in the matched field and contacted them and ask if they want to join this community. If each answers in the affirmative, the invention automatically forms a new community and the users are entered as members of that community.

The invention picks a name for the community that the users can later change. The name of the community is inserted into the database in the records of the present user and the matched user(s). Both the currently searching and the formerly searching users must agree to be in the community and the nature of the community, e.g., whether the community will be open to others or a closed confidential community. Another embodiment of the invention matches a searching user with members of existing communities found outside the invention but existing on a telephone system, the Internet, an intranet, extranet or standalone computer.

A community is defined as a list of two or more users that wish to communicate with each other based upon matching words of a search string. The matched search string or variation identifies the list. The list contains the telephone number or email addresses of the users. Users are permitted to email the list using a list serve or to post messages or chat with the community members. Users can remain anonymous if they so desire.

In the case of a non-null community entry, after the match is made only the present user is invited to join the already existing community. If the user answers in the affirmative, then the present user is added by the invention to the list for that extant community. The name of the community is added to the database for the present user. While the above text describes the primary embodiment of the invention, additional variations are now described. When matches are attempted, the invention adds contextual information to the user's search string. Users can have input and output via telephone, email, a person, fax, surface mail, or web-based email.

### BRIEF DESCRIPTION OF THE DRAWINGS

The present invention together with the above and other advantages may best be understood from the following detailed description of the embodiments of the invention illustrated in the drawings, wherein:

FIG. 1 is a block diagram of the invention and its relationship to the Internet or an intranet or a telephone system, the computer, the search engine, a listserve, a database server.

FIG. 2 is a block diagram of the E-COMMUNITY DATABASE showing various records, e.g., Record 1, Record 2, . . . , Record i.

FIG. 3 is a block diagram of Record i [Required information] and indicating the User ID, Search string, Community.

FIG. 4 is a block diagram of Record i [Optional information] with the date/time, context, scope measure, matching disable, anonymity, match age of request.

FIG. 5 is a block diagram of the record 1 after a sample search by dan@buzzit.com for “Boston Red Sox” User ID: dan@buzzit.com, Search string: “Boston Red Sox”, Community: Null.

FIG. 6 is a block diagram of the record 2 after search by carl@myisp.com for “Boston Red Sox” User ID: carl@myisp.com, Search string: “Boston Red Sox”, Community: Null.

FIG. 7 is a block diagram of the Records 1+2 after dan@buzzit.com and carl@myisp.com agree to form a community: “Boston Red Sox” with Records 1 and 2: Record 1, User ID: dan@buzzit.com, Search string: “Boston Red Sox”, Community: “Boston Red Sox” Record 2, User ID: carl@myisp.com, Search string: “Boston Red Sox”, Community: “Boston Red Sox”.

FIG. 8 is a block diagram of the Listserver after dan@buzzit.com and carl@myisp.com agree to form community “Boston Red Sox”, Community: “Boston Red Sox”, Members: User ID: dan@buzzit.com, User ID: carl@myisp.com.

### DETAILED DESCRIPTION OF THE INVENTION

Summary of Invention Plus Description

Electronic networks (e.g., the Internet) provide a number of services for its users. The primary services relevant to this patent application are communities or stand alone chat rooms, bulletin boards, list serves, electronic mail (email) and databases.

One of the major driving forces in the growth of networks in general and the Internet in particular has been the way it facilitates people's ability to find others of similar interests. Chat, bulletin boards, date matching services and list services are among the most popular activities on the net. People have a need to meet people and overcome the limitations of their physical separation.

However, one of the weaknesses of these existing systems is that they require users to either (1) enter a pre-defined gathering space or answer questions or (2) create a pre-determined profile. Such previous systems would by their nature limit the matches to the predetermined records and fields or a profile. If the participants or designers of existing matching systems fail to anticipate a new topic, interest or future need matching cannot occur.

This patent covers the apparatus, means and methods for automatically matching based upon the search terms entered into a telecommunications system, the Internet (World Wide Web), standalone computer, intranet or extranet. Further, it provides a means and method of comparing that search with prior search terms entered by others to make a match between similar searches—without needing to predetermine the basis for the match. After making a match the invention will invite the matched parties to join a frictionless and immediate electronic community if they so desire. These communities may be as small as just two people and as large as tens or hundreds of thousands of participants.

Who is benefited from this invention? People who are having trouble utilizing their new product purchase and would like to talk, chat, or email with someone who has bought the product earlier and figured out how to use it. Someone researching a rare disease and seeking a medical expert might use this invention with life saving results.

What else exists today that provides a portion of the functionality of the intention? ICQ, AOL and other Chat rooms, List serves, and UseNet groups are set up around a particular topic and these list serves are collected and administered or archived by Yahoo, ICQ, AOL, Topica and Google to name a few. The problem is that there typically needs to be a critical mass of 5-500 users to provide enough people to cover the wide range of questions that might be ask on any given topic. This invention only requires that there be as little as two people who have a similar interest and even if the earlier searcher is not currently looking for information on this subject this invention “remembers” his or her interest and offers to make a match.

Who kind of searches work best with the invention? The more specific the search the more targeted are the results. For instance someone searching for “jaguar” might get matched to people interested in cars, a cat, a Florida football team, a type of computer. So users who search for and XKE Jaguar acceleration will only get information about that car and not the jungle animal.

List servers are one of the components of this system. Email can be subdivided into one-to-one delivery and one-to-many. One-to-many is supported by list servers that maintain distribution lists. The distribution lists can be edited electronically by sending email directly to programs that maintain the lists. An example of the one-to-many email services is Usenet. Herein, we define the “many” in one-to-many as a community. Questions can be posed to community members so those users can solve problems. An object of a community is to provide users a way to ask for or share information with other users. Users who use a list serve or chat room often times cannot find communities to pose questions. Existing communities might be off-topic or too broad, or might not exist for a particular topic of interest.

The web is a database distributed across many computers. The various computers are connected electronically via hyperlinks in the data itself. A derivative service of the web is a means, described or referred to as “a search engine,” that enables users to locate information in the distributed database. An object of search engines is to help users find information on the Web. Users often times have difficulty obtaining information because the search engines find too much or too little information. Users also have trouble finding other people of similar interests.

The object of this invention is for users to combine the services of search, email, phones, fax, and the web to form communities. The present invention is designed to operate in person using a standalone computer, or a computer that provides communication to users with an archival database, interface to a phone handset on a telecommunications or data network, a wireless phone, automated agents and an electronic list server.

Users can communicate with the computer via direct network connections, serial lines (e.g., a modem connection), or directly via a keyboard/monitor combination. Users may be identified using various means including their email address, their login name, or other unique identifier; denoted their ID, or some combination of these. Other means of identifying users are possible and the present invention is not limited to those listed here.

The initial interaction of the user with the computer is to search for data. In the present embodiment of the invention, the data could be located on the computer itself, in distributed databases over a network connection (e.g., the Internet, intranet or extranet) or over a telephone system. The user performs a search utilizing natural language consisting of a series of keywords, phrases, or sentences, called a “search string.” Other types of search strings or search input are possible. The computer has means to pass the search string or search input to a search engine, which could be located on the computer itself or remotely on the network.

The invention will take people matched by their search string or search input and offer them the opportunity to enter an existing community or create a new community consisting of a text or voice chat room for real-time conversation via text or speech and a bulletin board. The community can also contain useful links to information, goods and services. Also the community will provide users with preferences to modify the look, feel and functionality of the community. For example users may not want a chat room and only want a bulletin board. Users may or may not want to shop from a community. Users may or may not want the community to suggest links to information, goods and services.

The computer also contains a storage mechanism (e.g., a disk) on which a database is maintained. In the present embodiment of the invention, there is database. This database provides a method of keeping track of search entries and who made those searches. The database maintains a set of entries containing a user ID, an associated search string, and a name or names of relevant community(s).

A community is a gathering of two or more people, virtual people or intelligent agents. A community contains a text or voice chat room and a bulletin board and useful links.

When the user enters a new search string and the search string is entered into the database, the community field is set to an empty string, denoted null. The invention will attempt to make match between a current search by one person and previous searches by one or more other person(s). The invention will also attempt to locate (match) a current search string with existing communities on the Internet, a telecommunications system or elsewhere. These existing communities might have been set up previously by the invention or exist elsewhere on a network. The invention stamps the time and date of the search. In a preferred embodiment of the invention, the database is routinely purged of entries older than a specified duration.

Matching telephone or Internet users based on any search terms with anyone else in the world subscribing or otherwise able to access this invention creates frictionless worldwide voice-based or data-based communities assembled in real-time with no bureaucracy.

Users are not required to enter profile information about themselves. Contextual information can be gathered from a larger universe of identifiers that indicate this person is a member of a consumer, chemical, electronics, job search, transportation, scientific, engineering, arts, social services, other industry verticals, or indicators of other broad categories about the type or nature of the user. For example, this information can be derived from their passage through a hierarchical search, a password, name of their originating site or the domain of the user.

A preferred embodiment of the invention should give users the ability to simply turn off the matching feature from their computer, browser or telephone. Also the invention can provide for levels of permission and levels of security. Likewise, an embodiment of the invention allows the users to specify the age of search matches. For example, a user might ask that no search match older than 6 months occur and another user might insist that no match older than 3 weeks be made.

After the user has entered his/her search string, the computer checks all other entries in the stored database to see if the present search string matches a previous search string in the database. This database incorporates one or more of the following methods: words in a database (with triggers or without), a hash table (faster but more memory intensive), a flat text file, an associative array (built on top of a hash table), or rules in a forward-chaining production system (fast but memory intensive). This same invention can be used on a telephone via sounds with associated meaning stored by a voice to text software program to the invention, such as Naturally Speaking or Via Voice. This enables the present invention for use on a data network and, or, telephone system to facilitate making matches over analog, digital or mixed phone and computer systems.

The mechanisms for implementing matching for a search string include the following methods: simple string match—does a word or series of words in the query match an item in the stored database within the system; a weighted string match—for each word in the query assign points to items in the system based on an inverse overall frequency score so that ‘rare’ words get higher scores than common words and return the items with the highest overall scores.

On these match methods the invention incorporates a number of methods as follows: closeness, increase the score where words matching in the item are close to each other in the query and/or item; thesaurus expansion: expand search words by adding synonyms; thesaurus inclusion, add synonym cross-reference to indexing mechanism instead of adding them to the search string; sounds-like: base search on soundex or similar codes instead of words; soundex-enhanced thesaurus: add words or cross-references based on synonyms of soundex-expansions; syntactic connectedness: increase the score where the words fall on the same branch of a parse tree (using any of several parsing methods); semantic connectedness: replace the syntactic parse with semantic analysis, based, for instance, on CYC technology or simpler forms of transformational analysis.

If a match is made, then one of two actions are taken depending if the community field in the matched record is null.

The first action is to consider the case of a null community entry. The invention contacts the currently searching and the previously searching users and asks them if they want to join a new community on the topic of the search string in the following manner. Initially the current searching user is contacted by the invention automatically. If that person indicates their interest in joining a community then the second action of the invention is to locate non-searching user(s) in the matched field and contacted them and ask if they want to join this community. If each answers in the affirmative, the invention automatically forms a new community and the users are entered as members of that community.

The invention picks a name for the community that the users can later change. The name of the community is inserted into the database in the records of the present user and the matched user(s). Both the currently searching and the formerly searching users must agree to be in the community and the nature of the community, e.g., whether the community will be open to others or a closed confidential community. Another embodiment of the invention matches a searching user with members of existing communities found outside the invention but existing on a telephone system, the Internet, an intranet, extranet or standalone computer.

A community is defined as a list of two or more users that wish to communicate with each other based upon matching words of a search string. The matched search string or variation identifies the list. The list contains the telephone number or email addresses of the users. Users are permitted to email the list using a list serve or to post messages or chat with the community members. Users can remain anonymous if they so desire.

In the case of a non-null community entry, after the match is made only the present user is invited to join the already existing community. If the user answers in the affirmative, then the present user is added by the invention to the list for that extant community. The name of the community is added to the database for the present user. While the above text describes the primary embodiment of the invention, additional variations are now described. When matches are attempted, the invention adds contextual information to the user's search string. Users can have input and output via telephone, email, a person, fax, surface mail, or web-based email. described. When matches are attempted, the invention adds contextual information to the user's search string. Users can have input and output via telephone, email, a person, fax, surface mail, or web-based email. A community is defined as a list of two or more users that wish to communicate with each other based upon matching words of a search string. The matched search string or variation identifies the list. Users can choose to contact others through a variety of means including but not limited to computer email, instant messages, SMS messages, bulletin boards, phone, fax, or chat room. FIG. 11.

What is claimed is:

1. A method for automatic formation of electronic communities, comprising the steps of:
a) providing a database for unique user identifier and associated search strings;
b) entering a first unique identifier for a first user and a first associated search string into said database;
c) determining whether said first search string substantially matches a search string previously stored in said database;
d) querying said first user whether said first user wants to join a community in response to a matching search string;
e) querying second user associated with said matching search string whether said second user wants to join a community with said first user; and
f) forming a community if said first user and said second user both respond affirmatively to community formation.
g) said community will initially be anonymous—without specific identifying information until both parties agree to identify themselves to the other.
h) displaying matches according to user preference to have matches sorted by date, closeness of search term, volume of similar searches, or a combination of some or all of these variables.
i) contacting these additional matches will be accomplished in the same manner as d)-g) shown above.
j) creating “MySearch” pages with the results of various searching and matching shown, as well as
k) the creation of certain organizational Searching and Matching pages to collect with permission the results of various searches and matching using this invention and making same available with appropriate levels of security.

2. The method of claim 1 wherein step f) further comprises the step establishing a connection between said first user and said second user over the Internet.

3. The method of claim 1 wherein steps d)-g) provide the user with means of ordering matches and sorting them by virtue of date, volume, or closeness of the search term.

4. The method of forming communities in claim 1 comprising the steps of two or more persons over a telephone wireless or landline system, the Internet, a computer network, or a standalone computer;

5. The method of creating a database referenced in claim 1 that also includes both new and previously created communities formed during a match on a standalone computer, networked computer or telephone system;

6. The method of allowing automated software agents to join in the creation of a new community referenced in claim 1 if one or more relevant community(ies) already exist(s), wherein only the present user is asked to join an existing community;

7. The method of determining the similarity of searches in claim 1 that can be determined using string matching;

8. The method of determining the similarity of searches in claim 1 using external contextual identifiers;

9. The method of determining the similarity of searches in claim 1 that can be determined using a sounds-like program;

10. The method of determining the similarity of searches in claim 1 that is determined using natural language processing in which the underlying meaning of the word or phrase is matched against the underlying meaning of the words or phrase of prior searches;

11. The method of determining the similarity of searches in claim 1 that can be determined using a neural net program;

12. The method of teaching a neural net in claim 1 to learn from previous matches;

13. The method of applying in claim 1 a system of security permissions where similarity of searches is constrained by users or an administrator or employer or supervisor with a system of security permissions controlled automatically or by the intervention of an actual person granting security based upon any criteria;

14. The method of inputting and outputting of claim 1 where said method of input of the search terms and output communications can be via: a) the spoken word into a phone, b)email, c) fax or d) web email, e) a network, f) automated software agents, g) instant messaging, h)SMS messaging, I)automated agents;

15. The method of claim 1 wherein the search is performed on a stand alone computer or other communications device to: a) telephone communications network, b) an intranet, c) an extranet, d) the Internet;

16. The method of providing in claim 1 to provide users with control over being notified of a match; and giving users the ability to turn such notification on and off, or to permit only recognized lists of users to be matched;

17. The method of identifying in claim 1 an identifying string for the user's password and his or her: a) email address, b) fax number, c) identifier from a redirector source, d) telephone number;

18. The method of setting the level of matching desired with respect to closeness, age of search, security and other constraints;

19. Choosing by users in claim 1 the nature of community they wish to be invited into (e.g., communities that are public, private, narrow, broad, computer, telephonic, text or voice, limited by geography, etc.);

20. Providing in claim 1 a community with one or more of the following functions: telephonic, chat, bulletin board, links to related goods and services, other chats, other bulletin boards, Usenet groups, other groups and functions;

21. The method of using in claim 1 a telecommunications system consisting of voice communication over wired or wireless digital or analog phone systems for matching;

22. The method of permitting users to choose to take advantage of speech to text and text to speech technologies;

23. The method of claim 1, including means to permit language translation so users can, for example, communicate within a single community in any language including Chinese, Russian, Spanish, Arabic, Japanese, Hebrew or English, and so forth;

24. The method of claim 1 as well as any other means of creating community including means to permit members of a community formed by the present invention to p1 a) conduct joint searches and to post same for private or public viewing
b) rate jointly and severally the content, consistency, depth and relevance of websites as well as other information valued by the community.

25. The apparatus for accomplishing 1a.-1k., 2-24.

26. the means for accomplishing 1a.-1k., 2-24.
